(19) United States
(12) Patent Application Publication
(10) Pub. No.: US 2019/0297867 A1
(43) Pub. Date: Oct. 3, 2019

(54) FISHING ROD COVER

(71) Applicant: Darin Robert Yowell, Bergheim, TX (US)

(72) Inventor: Darin Robert Yowell, Bergheim, TX (US)

(21) Appl. No.: 15/943,457

(22) Filed: Apr. 2, 2018

(51) Int. Cl. A01K 97/08

(52) U.S. Cl. CPC A01K 97/08

(57) ABSTRACT

A fishing rod cover for protecting a fishing rod from damage and preventing entanglement of fishing line includes an expandable sleeve for receiving the distal end of a fishing rod; and a flotation device for rendering the fishing rod cover buoyant in water. The expandable sleeve has an open proximal end, a closed distal end, and a rod receiving region between the open proximal end and the closed distal end. The flotation device is located at the closed distal end of the expandable sleeve, and comprises a cushion adapted to protect the tip of the fishing rod. The fishing rod cover has a semi-rigid rod receptacle, ensuing ease of insertion of the tip of the rod, as well as the guides supported on the rod. The flotation device is manufactured as an elastomeric foam cylindrical body having a bore through the longitudinal axis.

### FIELD OF THE INVENTION

The present invention relates to sporting. More particularly, the invention relates to a fishing rod cover specially adapted to both protect a fishing rod from damage and to prevent entanglement of the fishing line.

### BACKGROUND OF THE INVENTION

Many fishing rod covers have been proposed in the prior art with a view toward both protecting fishing rods from damage during transportation and/or storage, as well as for preventing entanglement of the fishing line of the stored or transported rod. Notwithstanding these efforts, however, the available rod covers are still lacking.

In particular, Applicant has noted that the available rod covers lack buoyancy in water, thereby making such covers highly susceptible to loss. Additionally, the available rod covers also fail to adequately protect fishing rods for damage, and, in particular, fail to address such damage as may occur in the use of the cover itself.

It is therefore an overriding object of the present invention to improve generally over the prior art by addressing at least each of these deficiencies of the prior art.

It is a further object of the present invention, however, to address these deficiencies in a simple article of manufacture that includes a flotation device with integral means for protection of the tip of a fishing rod.

### SUMMARY OF THE INVENTION

In accordance with the foregoing objects, the present invention—a fishing rod cover for protecting a fishing rod from damage and preventing entanglement of fishing line—generally comprises an expandable sleeve for receiving the distal end of a fishing rod; and a flotation device adapted to render the fishing rod cover buoyant in water. The expandable sleeve has an open proximal end, a closed distal end, and a rod receiving region between the open proximal end and the closed distal end. The flotation device is located at the closed distal end of the expandable sleeve, and comprises a cushion adapted to protect the tip of the fishing rod.

The expandable sleeve is manufactured from a circular, zig-zag patterned open weave mesh material, such as may include polyester filaments, polyethylene terephthalate filaments, or the like.

The open proximal end of the expandable sleeve of the fishing rod cover most preferably comprises a semi-rigid rod receptacle, ensuing ease of insertion of the tip of a fishing rod, as well as the guides dependently supported on the fishing rod.

The flotation device of the rod cover is, in at least the most preferred embodiment of the present invention, manufactured from an elastomeric foam. In order to protect the tip of the fishing rod, the flotation device comprises a cylindrical body having a bore through at least a proximal portion of the longitudinal axis.

The open proximal end of the expandable sleeve of the fishing rod cover may include a rod affixing grommet, through which the cover may be secured in place about a rod using, for example, a bungee cord or the like. Similarly, the closed distal end of the expandable sleeve most preferably includes a hanger grommet for hanging of the fishing rod cover. Because the expandable sleeve will grip an inserted rod in the manner of a “Chinese finger cuff,” the hanger grommet may be used to readily support the fishing rod cover with a fishing rod also dependently supported thereby.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a partially cutaway perspective view, a preferred embodiment of the fishing rod cover of the present invention;

FIG. 2 shows, in a cross section view taken through cut line 2-2 of FIG. 1, various details of the fishing rod cover of FIG. 1;

FIG. 3 shows, in a side elevation view, details of the most preferred implementation of the flotation device of the fishing rod cover of FIG. 1;

FIG. 4 shows, in a proximal end view, various additional details of the flotation device of FIG. 3; and

FIG. 5 shows, in a perspective view generally corresponding to the view of FIG. 1, details of the manner of use of the fishing rod cover of FIG. 1.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

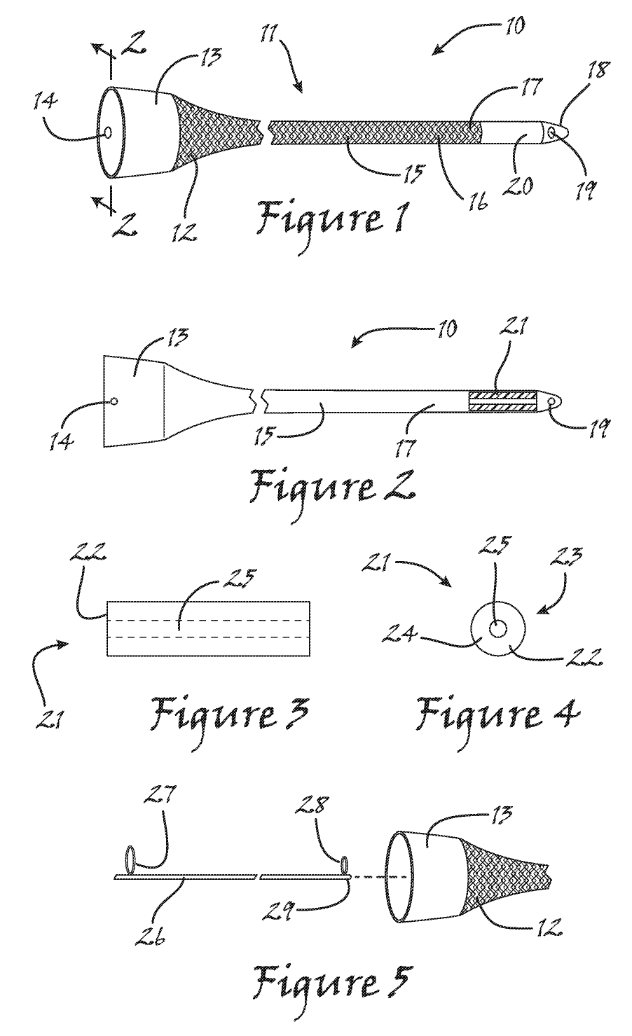

Referring now to the figures, and to FIG. 1 in particular, the fishing rod cover 10 for protecting a fishing rod 26 from damage, and also preventing entanglement of fishing line strung on the fishing rod 26, is shown to generally comprises an expandable sleeve 11 for receiving the tip 29 of a fishing rod 26, as well as that portion of the rod supporting at least the most distal guide 28, but most preferably all guides up to an including the largest guide 27, as shown in FIG. 5. Additionally, the fishing rod cover 10 of the present invention also comprises an integral flotation device 21, as best shown in FIGS. 2 through 4, adapted to render the fishing rod cover 10 buoyant in water.

The expandable sleeve 11 has an open proximal end 12, a closed distal end 17, and a rod receiving region 15 between the open proximal end 12 and the closed distal end 17. The flotation device 21 is located at the closed distal end 17 of the expandable sleeve 11, and comprises an integral rod tip cushion 23 adapted to protect the tip 29 of the fishing rod 26. Although shown in a partially cut away view in FIG. 1, it should be understood that the overall length of the expandable sleeve 11 should approximate the length of the portion of the fishing rod 26 to be enclosed within the rod cover 10.

The rod receiving region 15 of the expandable sleeve 11 is manufactured from a circular, zig-zag patterned open weave mesh material, such as may include polyester filaments, polyethylene terephthalate filaments, or the like. As will be appreciated by those of ordinary skill in the art, especially in light of this exemplary description, this weave type is well known to produce a braided sheathing 16 giving the well-known. “Chinese finger cuff” action, whereby the rod receiving region 15 of the expandable sleeve 11 is readily expansible to receive the rod 26 and its guides 28, but collapses about the rod 26 to secure itself about the rod 26.

The open proximal end 12 of the expandable sleeve 11 of the fishing rod cover 10 most preferably comprises a semi-rigid rod receptacle 13, ensuing ease of insertion of the tip 29 of a fishing rod 26, as well as the guides 28 dependently supported on the fishing rod 26. In the preferred manufacture of the present invention, the semi-rigid rod receptacle 13 is formed by inserting a preferably cylindrically shaped form into the proximal end 12 of the expandable sleeve 11, and then dipping or other otherwise coating the proximal end 12 of the expandable sleeve 11 in or with a protective coating such as, for example, synthetic rubber. As will be readily understood by those of ordinary skill in the art, the shape form is removed from the proximal end 12 of the expandable sleeve 11 during the rubber curing process, and before the rubber completely sets. In order to affix the cover 10 to a fishing rod, an anchor eye 14, such as a grommet is preferably conventionally provided as shown in FIGS. 1 and 2.

The flotation device 21 of the rod cover 10 is, in at least the most preferred embodiment of the present invention, manufactured from an elastomeric foam. In order to protect the tip 29 of the fishing rod 26, the flotation device 21 comprises a cylindrical body having a bore through at least a proximal end 22 of the longitudinal axis through the cylindrical body. In this manner, the flotation device 21 is made to comprise an integral rod tip cushion 23, comprising a compressible bed 24 about a rod tip receptacle 25.

In order to secure the flotation device 21 is place, which also serves as a stop for the tip 29 of the fishing rod 26, a cap 18 is formed at the most distal part of the closed end 17 of the expandable sleeve 11. In the most preferred manufacture of the present invention, the cap is formed heat-shrinking a wrapping of polyolefin or like material about the most distal portion of the braided sheathing 16. In order to doubly ensure stable placement of the flotation device 21, as well as to provide a measure of wear resistance to the distal end of the rod cover 10, the distal end of the cover, including most or all of the area of the braided sheathing 16 enveloping the flotation device 21, is dipped in, or otherwise coated with, a protective coating such as, for example, synthetic rubber.

In any case, the cap 18 most preferably includes a hanger grommet eye 19, such as a grommet, for hanging of the fishing rod cover 10. Because, as previously noted, the expandable sleeve 11 will grip an inserted fishing rod 10 in the manner of a “Chinese finger cuff,” the hanger eye 19 may he used to readily support the fishing rod cover 10 with a fishing rod 26 also dependently supported thereby.

Finally, each of the synthetic rubber coated regions 13, 20 of the rod cover 10 may be further coated with polyurethane or a like clear coat material. In this manner, the synthetic rubber coatings are protected from deterioration as may otherwise occur due to use by an angler of some type of fish attractants. Additionally, to the extent that branding or other printed matter is included in these regions, as is convenient, the poly ethane or like clear coating will also protect the ink or like appliqué.

In use, an angler simply slides the tip 29 of the fishing rod into an through the expandable sleeve 11, and utilizes the provided eyes 14, 19 as desired to secure and/or hang the rod cover 10. To remove the rod cover 10, the angler pushes the expandable sleeve 11 off of the rod 26.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. In any case, because the scope of the present invention is much broader than any particular embodiment, the foregoing detailed description should not be construed as a limitation of the scope of the present invention, which is limited only by the claims appended hereto.

What is claimed is:

1. A fishing rod cover for protecting a fishing rod from damage and preventing entanglement of fishing line, said fishing rod cover comprising:
an expandable sleeve for receiving the distal end of a fishing rod, said expandable sleeve having an open proximal end, a closed distal end, and a rod receiving region between said open proximal end and said closed distal end; and
a flotation device adapted to render the fishing rod cover buoyant in water; and
wherein said flotation device:
is located at said at said closed distal end of said expandable sleeve; and
comprises a cushion adapted to protect a tip of the fishing rod.

2. The fishing rod cover as recited in claim 1, wherein said expandable sleeve comprises a circular, zig-zag patterned open weave mesh.

3. The fishing rod cover as recited in claim 2, wherein said mesh comprises polyester filaments.

4. The fishing rod cover as recited in claim 2, wherein said mesh comprises polyethylene terephthalate filaments.

5. The fishing rod cover as recited in claim 2, wherein said open proximal end of said expandable sleeve comprises a semi-rigid rod receptacle.

6. The fishing rod cover as recited in claim 5, wherein said flotation device comprises an elastomeric foam.

7. The fishing rod cover as recited in claim 6, wherein said flotation device comprises a cylindrical body having a bore through at least a proximal portion of the longitudinal axis.

8. The fishing rod cover as recited in claim 2, wherein said flotation device comprises an elastomeric foam.

9. The fishing rod cover as recited in claim 8, wherein said flotation device comprises a cylindrical body having a bore through at least a proximal portion of the longitudinal axis.

10. The fishing rod cover as recited in claim 1, wherein said flotation device comprises an elastomeric foam.

11. The fishing rod cover as recited in claim 10, wherein said flotation device comprises a cylindrical body having a bore through at least a proximal portion of the longitudinal axis.

12. The fishing rod cover as recited in claim 5, wherein said flotation device comprises an elastomeric foam.

13. The fishing rod cover as recited in claim 1, wherein said open proximal end of said expandable sleeve comprises a rod affixing grommet.

14. The fishing rod cover as recited in claim 13, wherein said closed distal end of said expandable sleeve comprises a hanger grommet for hanging of the fishing rod cover.

15. The fishing rod cover as recited in claim 1, wherein said closed distal end of said expandable sleeve comprises a hanger grommet for hanging of the fishing rod cover.
